(19) United States
(12) Patent Application Publication
(10) Pub. No.: US 2025/0050415 A1
(43) Pub. Date: Feb. 13, 2025

(54) SILVER POWDER, MIXED SILVER POWDER, AND CONDUCTIVE PASTE, AND METHOD FOR MANUFACTURING SILVER POWDER AND MIXED SILVER POWDER

(71) Applicant: DOWA Electronics Materials Co., Ltd., Tokyo (JP)

(72) Inventor: Masanori FUJII, Tokyo (JP)

(73) Assignee: DOWA Electronics Materials Co., Ltd., Tokyo (JP)

(21) Appl. No.: 18/928,173

(22) Filed: Oct. 28, 2024

Related U.S. Application Data
(63) Continuation-in-part of application No. PCT/JP2024/018223, filed on May 16, 2024.

(30) Foreign Application Priority Data
May 17, 2023 (JP) 2023-081842

(51) Int. Cl. B22F 9/18; B22F 1/052; B22F 1/145

(52) U.S. Cl. CPC B22F 9/18; B22F 1/052; B22F 1/147; B22F 2301/255; B22F 2304/058

(57) ABSTRACT

Obtained are a silver powder and a mixed powder that can achieve low-resistance electrode wiring when printing wires, and a conductive paste using these powders. The silver powder includes, as 20% or more and less than 95% of all particles, silver particles whose main region of the silver particle upper surface is the (111) plane or a plane close to the (111) plane. The KAM value of the silver particles is 0.4 or more and 1.0 or less.

### TECHNICAL FIELD

The present disclosure relates to a silver powder, a mixed silver powder, and a conductive paste, and a method for manufacturing silver powder and mixed silver powder.

### BACKGROUND

Conductive pastes that have spherical silver powder and flat, flake silver powder mixed in as a filler, and that also contain a resin component, are used in applications such as electrode circuit formation for solar cells and other devices, filling of via holes, and adhesives for mounting components.

In the context of a silver paste consisting of silver powder as filler, a resin component, and an organic solvent, Patent Literature (PTL) 1 describes the use of a mixed silver powder in the silver powder. The mixed silver powder is a mixture of microspherical silver powder with an average particle size of 0.6 μm or less for the primary particles and ultra-thin silver powder with an average thickness of 50 nm or less for the primary particles.

PTL 2 describes silver particles that are flake-shaped, have a single crystal structure, and whose largest plane is the lattice plane (111).

### CITATION LIST

### Patent Literature

PTL 1: JP 2005-285673 A
PTL 2: JP 2019-173120 A

### SUMMARY

### Technical Problem

Conventionally, the wire width of electrode wiring has been approximately 25 μm, but demand exists for reducing the wire width to 15 μm or less. In the formation of thin wires with conductive paste, demand exists for printing to be possible without breaking the wires while further reducing the resistance of the electrode wiring.

It is therefore an aim of the present disclosure to obtain a silver powder and a mixed powder that can achieve further reduction in resistance of electrode wiring when printing fine wires, along with a conductive paste using such silver powder and mixed powder, and a method for manufacturing such silver powder.

### Solution to Problem

As a result of our diligent research to accomplish the above-described aim, we have completed the present disclosure, as described below. In other words, a summary for accomplishing the above-described aim is as follows.
(1) A silver powder including, as 20% or more and less than 95% of all particles, silver particles whose main region of a silver particle upper surface is a (111) plane or a plane close to the (111) plane, wherein a KAM value of the silver particles is 0.4 or more and 1.0 or less.
(2) The silver powder according to (1), wherein an aspect ratio yielded by dividing a median diameter on a volume basis according to laser diffraction by an average thickness of the silver particles in cross-sectional measurement is 1.2 or more and less than 4.0.
(3) The silver powder according to (1) or (2), wherein the average thickness of the silver particles in cross-sectional measurement is 310 nm or more.
(4) A method for manufacturing silver powder, the method including applying strain to a highly crystalline silver powder that includes, as 30% or more of all particles, silver particles whose main region of a silver particle upper surface is a (111) plane or a plane close to the (111) plane, a KAM value of the silver particles being less than 0.4, wherein the strain is applied by applying mechanical energy until the KAM value of the silver particles becomes 0.4 or more and 1.0 or less.
(5) The method for manufacturing silver powder according to (4), wherein the highly crystalline silver powder is obtained by adding an ascorbic acid-based reducing agent to a silver chelate complex solution after the silver chelate complex solution is prepared by addition of an amino acid.
(6) The method for manufacturing silver powder according to (4) or (5), wherein an aspect ratio, yielded by dividing a median diameter on a volume basis according to laser diffraction by an average thickness of the silver particles in cross-sectional measurement, of silver powder after the applying of strain is 1.2 or more and less than 4.0.
(7) The method for manufacturing silver powder according to any one of (4) to (6), wherein an average thickness of the highly crystalline silver powder in cross-sectional measurement is 310 nm or more, and an average thickness of silver powder in cross-sectional measurement after the applying of strain is 310 nm or more.
(8) A method for manufacturing mixed silver powder, the method including mixing the silver powder according to any one of (1) to (3) with micro silver powder having a larger specific surface area than the silver powder.
(9) The method for manufacturing mixed silver powder according to
(8), wherein the mixing is performed so that a mixing ratio of the silver powder according to any one of (1) to (3) is 10 wt % to 90 wt %.
(10) A mixed silver powder including at least silver particles whose main region of a silver particle upper surface is a (111) plane or a plane close to the (111) plane, wherein a KAM value of the silver particles is 0.4 or more and 1.0 or less.
(11) The mixed silver powder according to (10), wherein a specific surface area after mixing is 0.20 m²/g or more and 1.50 m²/g or less.
(12) A conductive paste including the silver powder according to any one of (1) to (3), a resin component, and a solvent.
(13) A conductive paste including the mixed silver powder according to (10) or (11), a resin component, and a solvent.

### Advantageous Effect

According to the present disclosure, a silver powder and a mixed powder that can achieve low-resistance electrode wiring when printing fine wires, and a conductive paste using these powders, can be obtained.

### BRIEF DESCRIPTION OF THE DRAWINGS

The patent or application file contains at least one drawing executed in color. Copies of this patent or patent application publication with color drawing(s) will be provided by the Office upon request and payment of necessary fee. In the accompanying drawings:

FIG. 1 is a diagram illustrating a plane close to the (111) plane in the present disclosure;

FIG. 2 is a diagram depicting an SEM observation image of silver particles, of the silver powder according to Example 1, whose main region of the silver particle upper surface is the (111) plane or a plane close to the (111) plane, together with an IPF map from EBSD measurement of the silver particle upper surface and a KAM map;

FIG. 3 is a diagram depicting an SEM observation image of silver particles, of the silver powder according to Example 2, whose main region of the silver particle upper surface is the (111) plane or a plane close to the (111) plane, together with an IPF map from EBSD measurement of the silver particle upper surface and a KAM map;

FIG. 4 is a diagram depicting an SEM observation image of silver particles, of the silver powder according to Example 3, whose main region of the silver particle upper surface is the (111) plane or a plane close to the (111) plane, together with an IPF map from EBSD measurement of the silver particle upper surface and a KAM map;

FIG. 5 is a diagram depicting an SEM observation image of silver particles, of the silver powder according to Comparative Example 1, whose main region of the silver particle upper surface is the (111) plane, together with an IPF map from EBSD measurement of the silver particle upper surface and a KAM map;

FIG. 6 is a diagram depicting an SEM observation image of silver particles, of the silver powder according to Comparative Example 2, whose main region of the silver particle upper surface is the (111) plane or a plane close to the (111) plane, together with an IPF map from EBSD measurement of the silver particle upper surface and a KAM map;

FIG. 7 is a diagram depicting an SEM observation image of silver particles according to Comparative Example 3, together with an IPF map from EBSD measurement of the silver particle upper surface and a KAM map;

FIG. 8 is a 2000×SEM observation image of Example 1; and

FIG. 9 is a 2000×SEM observation image of Comparative Example 3.

### DETAILED DESCRIPTION

Prior to the description of embodiments of the silver powder according to the present disclosure, the terms used in the present specification will be explained.

### <Plane Orientation>

The plane orientation of the silver powder according to the present disclosure is identified by mapping based on a stereo trigonometric color sample with the (111), (001), and (101) planes as vertices in an orientation distribution (IPF map) measured by Electron BackScatter Diffraction (EBSD). In this measurement, the crystalline sample on the stage is tilted widely in the SEM chamber so that the tilt of the stage is 60° to 70°, the sample is irradiated with an electron beam at a specified angle of incidence, and the diffracted electrons reflected from the sample are received by the camera of the EBSD to acquire a Kikuchi pattern. The orientation distribution (IPF map) is then created for the silver particle upper surface. In the Examples, an EBSD analyzer (OIM Analysis 6.2, manufactured by TSL Solutions Inc.) was used, and the measurement range was 60 μm×180 μm with a step size of 0.30 μm. Measurements were performed with SEM observation conditions of a 15 kV acceleration voltage, 1500× magnification, and 70° tilt. The orientation distribution (Inverse Pole Figure (IPF)) map was then created and evaluated, excluding unreliable measurement points with a reliability index (CI value) of 0.2 or less. Since irradiation of an electron beam on surfaces other than the silver particle upper surface does not allow acquisition of sufficient diffracted electrons or has a low reliability index, measurement points that are not on the silver particle upper surface can be excluded by setting of the reliability index. Therefore, the area where the IPF map is created is defined as the silver particle upper surface in the present disclosure.

### <Surface Close to (111) Plane>

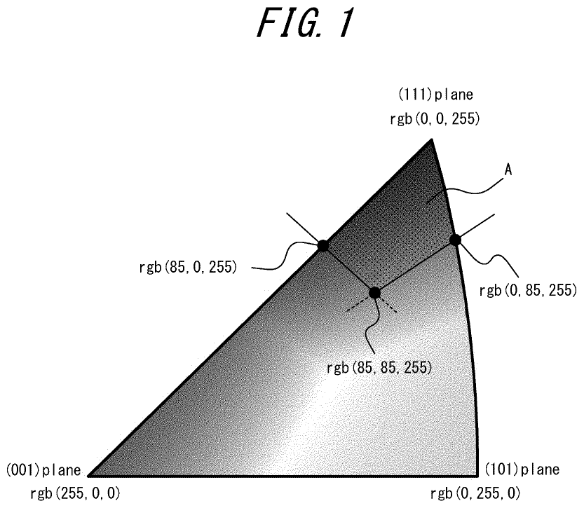

In the IPF map measured by EBSD, each point on the map is mapped based on a stereo triangular color sample graph with the points representing the (111), (001) and (101) planes as vertices. A schematic diagram of the color sample for this mapping is depicted in FIG. 1. The points on the IPF map and the color sample graph are actually distinguished between by RGB colors. For example, the (111) plane is RGB=(0, 0, 255) (color name: blue), the (001) plane is RGB=(255, 0, 0) (color name: red), and the (101) plane is RGB=(0, 255, 0) (color name: green). A region A (the region of the color close to blue) surrounded by lines traversing RGB=(0, 0, 255), RGB=(0, 85, 255), RGB=(85, 85, 255) and RGB=(85, 0, 255) in the CSS color code in FIG. 1 is treated as the “surface close to the (111) plane” in the present specification. If the main region of the silver particle upper surface is represented by the color corresponding to region A in this color sample graph in the IPF map when the silver particle is actually observed, the surface of the silver particle can be regarded as a “surface near the (111) plane”. The “main region” refers to the region that is 60% or more of the colored region in this IPF map. In the present specification, the percentage is obtained by evaluating 15 or more silver particles observed on the IPF map. In other words, in one silver particle observed on the IPF map, if 60% or more of the silver particle upper surface is a surface close to the (111) plane, the silver particle is considered to be a silver particle whose main region of the silver particle upper surface is the (111) plane or a plane close to the (111) plane.

### <KAM Value>

The KAM value of a silver particle is determined by increasing the observation magnification for silver particles whose main region of the silver particle upper surface is the (111) plane or a plane close to the (111) plane, as confirmed in the above-described IPF map, so that one silver particle is included in the field of view. A strain distribution (KAM map) measured by SEM-EBSD on the silver particle upper surface is then created, and the average value of a strain histogram on the silver particle upper surface is calculated. The Kernel Average Misorientation (KAM) value of the strain distribution on the silver particle upper surface is evaluated for each of 10 or more of the above-described silver particles observed on the IPF map. The KAM value according to the present disclosure is the average of the KAM values of the silver particle upper surface of 10 or more silver particles (silver particles whose main region of the silver particle upper surface is the (111) plane or a plane close to the (111) plane). In the Examples, an orientation distribution (Inverse Pole Figure (IPF)) map of the corresponding silver particle upper surface was created in the same way as the IPF map observation conditions described above, except that the conditions of the EBSD analyzer were set to a measurement range of 6 μm×18 μm and a step size of 40 nm, and an SEM observation condition of 15000× magnification was set. The KAM map was then acquired.

### <Median Diameter>

The median diameter of silver powder according to the present disclosure on a volume basis according to laser diffraction is obtained from a particle size distribution measured by a laser diffraction scattering-type device for measuring particle size distribution. In the present embodiment, a case is described in which a Microtrac device for measuring particle size distribution MT-3300EXII (hereinafter simply referred to as a device for measuring particle size distribution), manufactured by MicrotracBEL Corp., is used as a laser diffraction scattering-type device for measuring particle size distribution. The particle size distribution of silver powder may be measured by dispersion in a predetermined dispersion medium, i.e., by wet measurement. In the Examples, a dispersion liquid was prepared by adding 0.1 g of silver powder to 40 mL of isopropyl alcohol as a dispersion medium and dispersing the silver powder for 2 minutes with an ultrasonic homogenizer (US-150T, manufactured by NISSEI Corporation; 19.5 kHz, tip diameter 18 mm). The dispersion liquid was then provided to the device for measuring particle size distribution, and the particle size distribution of the silver powder was measured.

In the present specification, the median diameter on a volume basis is also described as the cumulative 50% diameter or D50. The cumulative 50% diameter is the diameter at which the cumulative amount of particles, on a volume basis, reaches 50% starting from the smallest particle diameter in the particle size distribution. Similarly, the cumulative 10% diameter is the diameter at which the cumulative amount of particles, on a volume basis, reaches 10% starting from the smallest particle diameter in the particle size distribution. The cumulative 90% diameter is the diameter at which the cumulative amount of particles, on a volume basis, reaches 90% starting from the smallest particle diameter in the particle size distribution. The cumulative 10% diameter, cumulative 50% diameter, and cumulative 90% diameter on a volume basis may be referred to below as D10, D50, and D90, respectively.

### <Average Thickness>

The average thickness, in cross-sectional measurement, of the silver particles in the silver powder according to the present disclosure is the average value of the thickness obtained based on an SEM observation image of a cross-section of silver particles. In the Examples, the SEM observation image for understanding the cross-sectional shape of silver particles was obtained by polishing the resin-hardened silver powder with a cross-section polisher ArBlade 5000 (manufactured by Hitachi High-Tech Corporation) to expose a cross-section, followed by SEM observation of the cross section of the silver particles at a 5000× magnification. When an individual particle image in the SEM observation image of the cross-section of silver particles is surrounded by a rectangle with minimum area, the thickness of a silver particle refers to the short edge of the rectangle. The average thickness refers to the average of the measured short sides of 20 or more silver particles imaged during the thickness measurement.

### <Aspect Ratio>

In the silver powder of the present disclosure, the value obtained by dividing the median diameter on a volume basis according to laser diffraction by the average thickness of the silver particles in cross-sectional measurement is used as the aspect ratio and is referred to as the “aspect ratio yielded by dividing the median diameter on a volume basis according to laser diffraction by the average thickness of the silver particles in cross-sectional measurement”.

### <Specific Surface Area>

The specific surface area (SSA) of the silver powder according to the present disclosure is determined by the BET method. In the Examples, the values measured by a Macsorb HM-model 1210, manufactured by Mountech Co., were used.

The following is a detailed description of the silver powder according to the present embodiment. The silver powder in the present embodiment is a powder as an aggregate of silver particles (hereinafter simply referred to as “silver powder”).

### (Silver Powder)

The silver powder according to the present embodiment includes, as 20% or more and less than 95% of all particles, silver particles whose main region of the silver particle upper surface is the (111) plane or a plane close to the (111) plane in SEM-EBSD measurement, and a KAM value of the silver particles is 0.4 or more and 1.0 or less. A conductive paste using these silver particles can achieve low-resistance electrode wiring when printing fine wires.

The silver powder according to the present disclosure includes silver particles whose main region of the silver particle upper surface is the (111) plane or a plane close to the (111) plane in SEM-EBSD measurement preferably as 30% or more, and more preferably as 40% or more, of all particles, Even when the silver powder is configured only by the plane close to the (111) plane, the silver powder of the present disclosure more preferably includes silver particles whose main region of the silver particle upper surface is the (111) plane or a plane close to the (111) plane as less than 70% of all particles. The content of the aforementioned “silver particles whose main region of the silver particle upper surface is the (111) plane or a plane close to the (111) plane” in the silver powder is the number ratio of the number of silver particles whose main region of the silver particle upper surface is the (111) plane or a plane close to the (111) plane, as described above, to the total number of particles observed in the IPF map (mapping based on the color sample graph) in EBSD measurement performed by dispersing and arranging silver particles so as not to overlap insofar as possible. This number ratio is also referred to below as the IPF value.

The average KAM value yielded by evaluating 10 or more silver particles whose main region of the silver particle upper surface is the (111) plane or a plane close to the (111) plane in SEM-EBSD measurement is 0.4 or more and 1.0 or less, and the KAM value is preferably 0.5 or more. The silver particles of the present disclosure have distortion compared to silver particles yielded by crystal growth to have a (111) plane, and a further reduction in resistance of electrode wiring can be obtained by distortion such that the KAM value is in the range of 0.4 or more and 1.0 or less.

Furthermore, in the silver powder according to the present disclosure, the average thickness of the silver particles in cross-sectional measurement is preferably 310 nm or more, and the aspect ratio yielded by dividing the median diameter on a volume basis according to laser diffraction by the average thickness is preferably 1.2 or more and less than 4.0. If the aspect ratio is in the range of 1.2 or more and less than 4.0, fine wire printability is improved compared to flat-shaped silver particles with an aspect ratio of 4.0 or more. If the thickness is less than 310 nm, it is difficult to form a dense fired film, and the conductivity of the fired film tends to decrease. In addition, the paste viscosity when made into a paste may increase, and the printability of the paste may decrease. In addition, a greater average thickness facilitates application of strain that results in the above-described KAM value when “applying mechanical energy” during manufacturing, described below. The average thickness is more preferably 400 nm or more, even more preferably 500 nm or more. Also, the average thickness is preferably 3000 nm or less. An average thickness exceeding 3000 nm may make it difficult to print fines wires. The aspect ratio is more preferably 1.5 or more, even more preferably 1.8 or more. The aspect ratio is more preferably 3.8 or less, even more preferably 3.6 or less.

Silver particles whose main region of the silver particle upper surface is the (111) plane or a plane close to the (111) plane in SEM-EBSD measurement preferably have a particle shape that is an abbreviated polygonal flat plate or an abbreviated polygonal pillar derived from the face-centered cubic crystal structure of silver. In other words, the silver particle upper surface is preferably an upper surface having a polygonal shape of an abbreviated polygonal flat plate or an upper surface having a polygonal shape of an abbreviated polygonal pillar. Furthermore, a particle shape with rounded corners is also preferable. An abbreviated polygonal plate or an abbreviated polygonal pillar may have rounded corners, as long as a portion of the upper surface (bottom surface) and side surfaces to be considered as a polygonal flat plate or a polygonal pillar is observed.

The specific surface area of the silver powder according to the present disclosure is preferably 0.10 m²/g or more and 1.00 m²/g or less. The lower limit of the specific surface area is more preferably 0.15 m²/g or more, even more preferably 0.20 m²/g or more. The upper limit of the specific surface area is more preferably 0.90 m²/g or less, even more preferably 0.80 m²/g or less.

### (Method for Manufacturing Mixed Silver Powder)

A mixed powder is preferably obtained by mixing the silver powder according to the present disclosure with micro silver powder having a larger specific surface area than the silver powder according to the present disclosure. By mixing the silver powder of the present disclosure with micro silver powder, the filling ratio of silver in the paste can be increased when it is made into conductive paste, and as a result, the resistance of the electrode wiring can be further reduced. The mixing is preferably performed so that the mixing ratio of the silver powder according to the present disclosure in the mixed silver powder becomes 10 wt % to 90 wt %. Mixing the silver powder according to the present disclosure at a ratio of 20 wt % or more is also preferable, and mixing at 30 wt % or more is also preferable. Mixing the silver powder according to the present disclosure at a ratio of 80 wt % or less is more preferable, and mixing at 70 wt % or less is even more preferable. The micro silver powder with a larger specific surface area than the silver powder of the present disclosure can be silver powder with an IPF value of zero, and the average aspect ratio by the long/short sides of the bounding rectangle with the smallest area is preferably less than 1.5. The average Heywood diameter of the micro silver powder that has a larger specific surface area than the silver powder according to the present disclosure is more preferably smaller than the average thickness in cross-sectional measurement of the silver particles according to the present disclosure, and the average Heywood diameter of the micro silver powder is even more preferably less than 500 nm. The average aspect ratio of the micro silver powder and the average Heywood diameter of the micro silver powder are obtained by measuring the long/short sides of the bounding rectangle with the smallest area of the external shape of each of a total of 400 or more silver particles, and their Heywood diameter, using image analysis-based particle size distribution measurement software (Mac-View, produced by Mountech Co.) on SEM images.

### (Mixed Silver Powder)

The mixed silver powder according to the present disclosure includes at least silver particles whose main region of the silver particle upper surface is the (111) plane or a plane close to the (111) plane, and a KAM value of the silver particles is 0.4 or more and 1.0 or less. Regardless of the mixing ratio with micro silver powder whose IPF value is zero, if the mixed silver powder includes the silver powder according to the present disclosure, then silver particles whose main region of the silver particle upper surface is the (111) plane or a plane close to the (111) plane appears in the IPF map. The specific surface area of the mixed silver powder is preferably 0.20 m²/g or more and 1.50 m²/g or less, more preferably 0.30 m²/g or more and 1.20 m²/g or less, and even more preferably 0.35 m²/g or more and 1.10 m²/g or less. As a suitable range for conductive paste useable to print fine wires, the specific surface area is even more preferably between 0.40 m²/g or more and 0.80 m²/g or less, most preferably 0.60 m²/g or more and 0.75 m²/g or less.

In the aforementioned mixed silver powder, the number ratio (IPF value) of the number of silver particles whose main region of the silver particle upper surface is the (111) plane or a plane close to the (111) plane in SEM-EBSD measurement to the total number of particles is difficult to measure, since the number of particles per unit weight of micro silver powder is large. However, in an IPF map containing silver particles of the present disclosure in the field of view, for example, the IPF value is preferably 0.1% or more, more preferably 1% or more. On the other hand, the mixed silver powder preferably contains the silver particles as 90% or less of all particles, more preferably 80% or less, and even more preferably 70% or less. The reason is that if the percentage of the silver particles is too high, the number of starting points for necking by polycrystalline particles during electrode formation by heat treatment decreases.

### (Conductive Paste)

The conductive paste according to the present disclosure includes the above-described mixed silver powder, a resin component, and a solvent. Solvents and binders, and the like can be selected according to the mode of use.

### (Method for Manufacturing Silver Powder)

In describing the method for manufacturing silver powder according to the present disclosure, a silver powder that is referred to as a highly crystalline silver powder includes, as 30% or more of all particles, silver particles whose main region of a silver particle upper surface is a (111) plane or a plane close to the (111) plane, a KAM value of the silver particles being less than 0.4. The method for manufacturing silver powder according to the present disclosure includes applying strain to the highly crystalline silver powder that includes, as 30% or more of all particles, silver particles whose main region of the silver particle upper surface is the (111) plane or a plane close to the (111) plane, by applying mechanical energy until the KAM value of the silver particles becomes 0.4 or more and 1.0 or less. The average thickness of the highly crystalline silver powder is preferably 310 nm or more in cross-sectional measurement of the silver particles. The average thickness in cross-sectional measurement of silver particles in the silver powder obtained by applying mechanical energy is preferably 310 nm or more, and the average aspect ratio is preferably 1.2 or more and less than 4.0. In the silver particles whose main region of the silver particle upper surface is the (111) plane or a plane close to the (111) plane, the highly crystalline silver powder preferably has a thickness of 310 nm or more in the perpendicular direction relative to the (111) plane or the plane close to the (111) plane.

Specific aspects of a manufacturing method suitable for manufacturing the silver powder according to the present embodiment are described below. The method for manufacturing silver powder described below is only an example of realizing the manufacturing of silver powder according to the present embodiment, and the silver powder according to the present embodiment is not limited to the silver powder manufactured by the manufacturing method described below.

First, a silver solution is preferably prepared as a raw material. This silver solution can be any aqueous solution containing silver ions. For example, a silver nitrate solution can be used. Other silver solutions may be silver sulfate, silver cyanide, or silver acetate solutions.

The temperature of the silver solution may be adjusted after pH adjustment. The pH is preferably 1.0 or more and 5.0 or less, more preferably 1.5 or more and 3.0 or less. Adjustment can be made using concentrated nitric acid, for example. The silver particle size can be adjusted by adjusting the pH. The temperature of the silver solution is preferably 10° C. or more and 35° C. or less, more preferably 17° C. or more and 30° C. or less. Within this temperature range, recovery as silver particles is possible by reduction. The silver particle size also can be optimized by setting the temperature in this range.

Next, a chelating compound is preferably mixed in as a complexing agent to complex the silver ions in the silver solution so as to yield a silver chelate complex solution. An EDTA-4Na solution, for example, can be used as a chelating compound, and other examples that can be used include ethylenediamine, glycine, citric acid, malic acid, succinic acid, alkenyl succinic acid, and DMSA. An amino acid is also preferably added as an additive to assist with complexing when mixing in a chelating compound. Aqueous L(+)-arginine solution, for example, can be used as an amino acid, and other examples that can be used include L-alanine, L-asparagine, L-glutamine, L-phenylalanine, L-glutamic acid, L-glutamine, L-aspartic acid, L-glycine, and L-tryptophan. The addition of an amino acid can increase the thickness of the silver particles, resulting in a highly crystalline silver powder with an average thickness of 310 nm or more.

A highly crystalline silver powder can be generated and precipitated by adding a reducing agent in the resulting silver chelate complex solution. At this time, a surface treatment agent is also preferably added at the same time to improve dispersibility during precipitation of the highly crystalline silver powder. Although known reducing agents can be used as reducing agents, aqueous L-ascorbic acid solution, aqueous sodium L-ascorbate solution, aqueous isoascorbic acid solution, or the like are preferably used because they enable reduction even in an acidic pH range and enable easy control of the particle size and aspect ratio. Fatty acids or their salts can be used as surface treatment agents, such as a stearic acid emulsion, oleic acid, castor cured resin acid, palmitic acid, myristic acid, lauric acid, capric acid, ricinoleic acid, linoleic acid, or linolenic acid.

Although any method and raw materials can be used in the production of the above-described highly crystalline silver powder, the addition of an amino acid to a silver chelate complex solution, followed by the addition of an ascorbic acid-based reducing agent, is particularly preferable, because the highly crystalline silver powder grows thicker and is more easily machine processed by virtue of its good dispersion.

The highly crystalline silver powder in a slurry (suspension) thus obtained in a wet reaction can be recovered as dry powder by solid-liquid separation through filtration or the like followed by washing and drying.

A Nutsche filter or the like may be used to filter the slurry, and filtration, washing with water, and drying may be performed sequentially. During washing with water, the electrical conductivity of the washing solution is measured, and washing is preferably repeated until the electrical conductivity falls to 2.0 mS/m or less, more preferably until the electrical conductivity falls to 1.0 mS/m or less.

After washing, the highly crystalline silver powder is preferably sufficiently dewatered and then dried. Dryers such as forced circulation air dryers, vacuum dryers, and airflow dryers can be used for drying. As for the temperature during drying, drying is preferably conducted at 100° C. or less, more preferably at 80° C. or less. Exceeding 100° C. is undesirable because the silver particles in the silver powder may aggregate and sinter. The drying time can be set to any appropriate time according to the temperature, but 5 hours or more is preferable.

Here, mechanical energy is applied to the highly crystalline silver powder after drying to apply to strain the silver particles in the silver powder until the KAM value becomes 0.4 or more and 1.0 or less. The average thickness of the highly crystalline silver powder is preferably 310 nm or more.

In the present disclosure, “applying mechanical energy” means applying physical force to the silver powder, such as shear force from the rotation of stirring blades, collision force between silver particles, or other mainly mechanical energy. As equipment, it is preferable to use an electric mill, such as a sample mill with stirring blades that rotate at high speed, or an airflow grinder. In the present disclosure, “applying strain” means slightly distorting the crystal plane of single crystal particles in the highly crystalline silver powder. By slightly distorting the crystal plane, the in-plane conductivity can be activated without significant loss of conductivity, and necking can be promoted during heat treatment for electrode formation. This is advantageous in reducing the resistance of the electrode wiring. Sharp corners originating from the crystalline surface of the produced highly crystalline silver powder are also preferably removed as a result of “applying strain”, since this results in little risk of causing clogging during printing. Even if mechanical energy is applied to the silver powder as in Comparative Example 2 described below, the KAM value will not be 0.4 or more and 1.0 or less if the energy applied to the silver powder is small and merely breaks up aggregations. Sufficient mechanical energy needs to be applied in order to apply strain until the KAM value becomes 0.4 or more and 1.0 or less.

A conductive paste using the silver particles obtained in this way can achieve low-resistance electrode wiring when printing fine wires.

### EXAMPLES

Examples of silver powder, conductive paste, and a method for manufacturing silver powder are described below.

### Example 1

First, 3000 g of a silver nitrate solution containing 170 g of silver was prepared, and the pH was adjusted by adding 45.4 g of 67.5 wt % concentrated nitric acid. The temperature was then adjusted to 25° C. While stirring this solution, 0.43 g of 4.3 wt % EDTA-4Na solution (Chelest OD-50) and 10.7 g of 5 wt % L (+)-arginine solution were added to obtain a silver complex solution. Subsequently, 1500 g of 10 wt % L-ascorbic acid solution was added to this silver complex solution, the stirring was stopped, and the solution was allowed to stand for 4 minutes 30 seconds so that the silver complex solution was reduced. Stirring was resumed, and 2.03 g of a commercially available stearic acid emulsion (Selosol 920, manufactured by Chukyo Yushi Co., Ltd., containing 82% water) was added to obtain a slurry containing silver particles.

The slurry was then filtered and washed with water until the electrical conductivity of the liquid after passing water was 0.5 mS/m or less. The result was vacuum dried at 73° C. for 10 hours to obtain highly crystalline silver powder.

Silver powder as an aggregate of silver particles according to Example 1 was obtained by feeding 50 g at a time into a sample mill (Model SK-10, manufactured by Kyoritsu Riko Corporation) and applying strain for 60 seconds at maximum rotational speed as the process for applying strain.

Mixed silver powder for obtaining conductive paste was prepared by mixing the silver powder according to Example 1 and micro silver powder (AG-2-1C agent added, manufactured by DOWA Hightech) at a weight ratio of 1:1 so that the SSA at the time of mixing was approximately 0.6 m²/g to 0.75 m²/g. The IPF value of AG-2-1C agent added is zero, the median diameter (D50) on a volume basis is 0.80 μm, and the specific surface area is 1.00 m²/g. The external shape of each of a total of 400 or more silver particles was measured using image analysis-based particle size distribution measurement software (Mac-View, produced by Mountech Co.) on SEM images of silver particles of AG-2-1C agent added, yielding an average aspect ratio of 1.3 and an average Heywood diameter of 0.34 μm.

### Example 2

The silver powder according to Example 2 was obtained in the same manner as in Example 1, except that the amount of nitric acid was 30.2 g.

Mixed silver powder for obtaining conductive paste was prepared by mixing the silver powder according to Example 2 and AG-2-1C agent added, manufactured by DOWA Hightech, at a weight ratio of 1:1 so that the SSA at the time of mixing was approximately 0.6 m²/g to 0.75 m²/g.

### Example 3

The silver powder according to Example 2 was obtained in the same manner as in Example 1, except that the amount of nitric acid was 15.1 g.

Mixed silver powder for obtaining conductive paste was prepared by mixing the silver powder according to Example 3 and AG-2-1C agent added, manufactured by DOWA Hightech, at a weight ratio of 1:1 so that the SSA at the time of mixing was approximately 0.6 m²/g to 0.75 m²/g.

### Comparative Example 1

The silver powder according to Comparative Example 1 was obtained in the same manner as in Example 1, except that strain was not applied.

The silver powder according to Comparative Example 1 is the aforementioned highly crystalline silver powder.

Mixed silver powder for obtaining conductive paste was prepared by mixing the silver powder according to Comparative Example 1 and AG-2-1C agent added, manufactured by DOWA Hightech, at a weight ratio of 1:1 so that the SSA at the time of mixing was approximately 0.6 m²/g to 0.75 m²/g.

### Comparative Example 2

The silver powder according to Comparative Example 2 was obtained in the same manner as in Example 1, except that the equipment used to apply strain was changed to a coffee mill (ECG62, manufactured by Melita).

Mixed silver powder for obtaining conductive paste was prepared by mixing the silver powder according to Comparative Example 2 and AG-2-1C agent added, manufactured by DOWA Hightech, at a weight ratio of 6:4 so that the SSA at the time of mixing was approximately 0.6 m²/g to 0.75 m²/g.

### Comparative Example 3

FA-S-20, manufactured by DOWA Hightech, was prepared as silver powder. After mixing a lubricant with roughly spherical silver powder, this silver powder was flattened using a vibrating mill.

Mixed silver powder for obtaining conductive paste was prepared by mixing the silver powder according to Comparative Example 3 and AG-2-1C agent added, manufactured by DOWA Hightech, at a weight ratio of 7:3 for the SSA at the time of mixing to approach the SSA after mixing of the other silver powders, since the SSA of the silver powder in Comparative Example 3 is larger than that of the other silver powders (Examples 1 to 3 and Comparative Examples 1 and 2).

A summary of the manufacturing conditions and the like for the silver powders according to the aforementioned Examples and Comparative Examples is illustrated in Table 1.

TABLE 1

| | Manufacturing Conditions of Highly Crystalline Silver Powder | | | | | | | | |
|---|---|---|---|---|---|---|---|---|---|
| | silver | | | | | | | | |
| | nitrate solution | concentrated | | | L(+)- | ascorbic | | | |
| | (silver | nitric | | EDTA-4Na | arginine | acid | | Strain Application | |
| | content) | acid | temperature | solution | solution | solution | selosol | device | time |
| | g | g | ° C. | g | g | g | g | used | sec |
| Example 1 | 3000 (170) | 45.4 | 25 | 0.043 | 10.7 | 1500 | 2.03 | SK-M10 | 60 |
| Example 2 | 3000 (170) | 30.2 | 25 | 0.043 | 10.7 | 1500 | 2.03 | SK-M10 | 60 |
| Example 3 | 3000 (170) | 15.1 | 25 | 0.043 | 10.7 | 1500 | 2.03 | SK-M10 | 60 |
| Comparative | 3000 (170) | 45.4 | 25 | 0.043 | 10.7 | 1500 | 2.03 | — | — |
| Example 1 | | | | | | | | | |
| Comparative | 3000 (170) | 45.4 | 25 | 0.043 | 10.7 | 1500 | 2.03 | ECG62 | 60 |
| Example 2 | | | | | | | | | |
| Comparative | FA-S-20 manufactured by DOWA Hightech | | | | | | | | |
| Example 3 | | | | | | | | | |

### (Silver Powder Evaluation)

The silver powders were evaluated as described below.

First, the specific surface area of silver powder was measured using Macsorb HM-model 1210, manufactured by Mountech Co. When measuring the specific surface area, the value measured by the BET 1-point method was used after deaeration by passing He-N₂ mixed gas (30% nitrogen) through the measuring apparatus at 60° C. for 10 minutes.

The particle size distribution of silver powder was measured using a laser diffraction particle size analyzer (Microtrac Particle Size Analyzer MT-3300EXII, manufactured by MicrotracBEL Corp.). Immediately before the measurement, 0.3 g of silver powder was added to 40 mL of isopropyl alcohol and dispersed for 5 minutes by an ultrasonic cleaner with an output of 45 W. The particle size distribution of silver particles in the dispersion was then measured. The median diameter (cumulative 50% particle diameter, so-called D50) was determined on a volume basis. The specific surface area and particle size distribution were measured in the same way for the mixed silver powder.

Next, cross-sectional observation of the silver particles in the silver powder was performed. First, 4 g of each silver powder was added to a mixture of 0.7 g of Specifix Resin and 0.1 g of Specifix-20 Curing Agent as a curing agent and was mixed lightly with a spatula. The mixture was then defoamed in a decompressed desiccator for 30 minutes and mixed again with a spatula. The resulting paste was placed in a mold and left overnight at room temperature, and the resin was hardened. A cross-section of the resin-hardened silver powder was exposed by polishing with a cross-section polisher ArBlade 5000 (manufactured by Hitachi High-Tech Corporation), and SEM observation images were taken with an FE-SEM IT-800SHL (manufactured by JEOL Ltd.). The thickness was calculated as the short edge of a rectangle with minimum area surrounding an individual particle image.

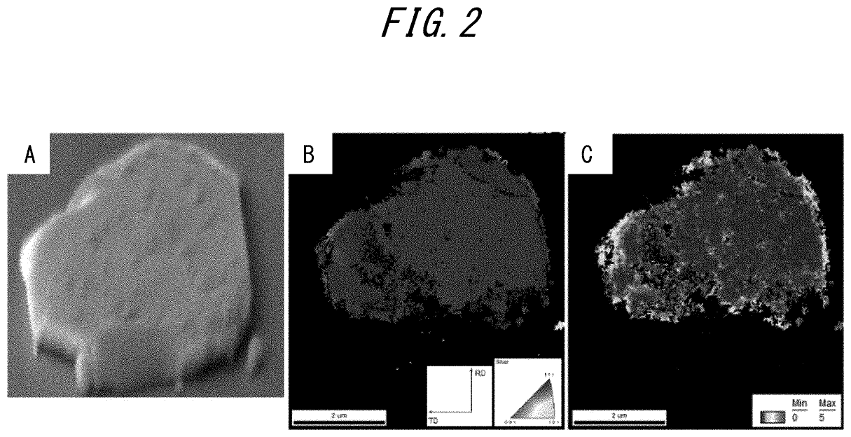

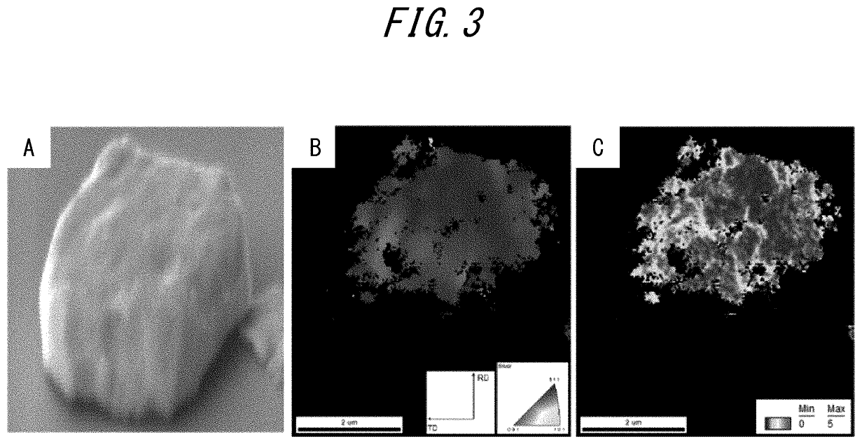

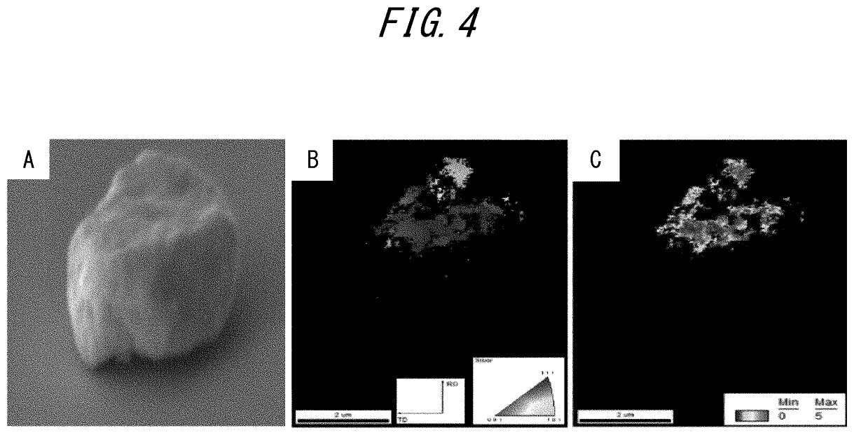

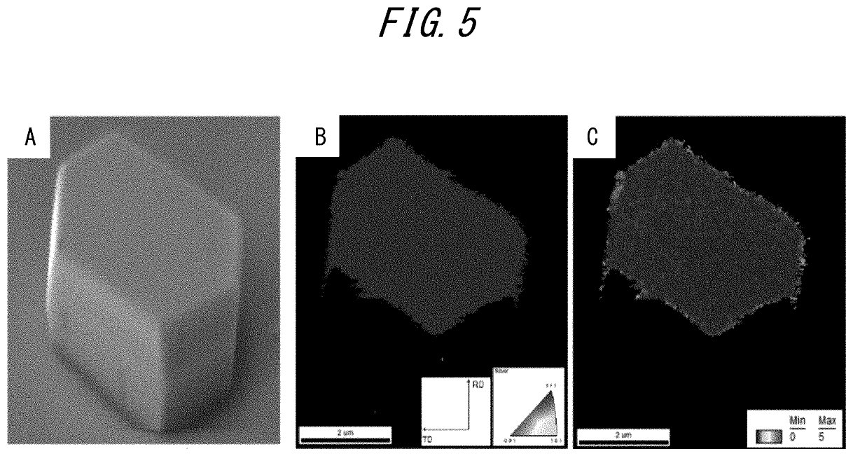

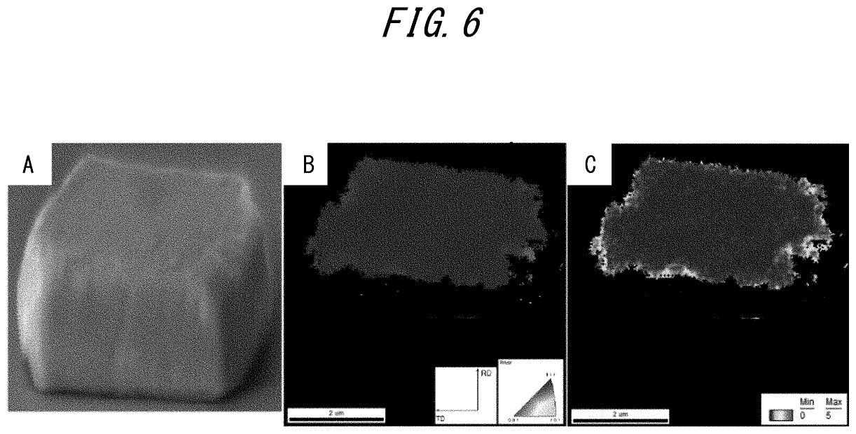

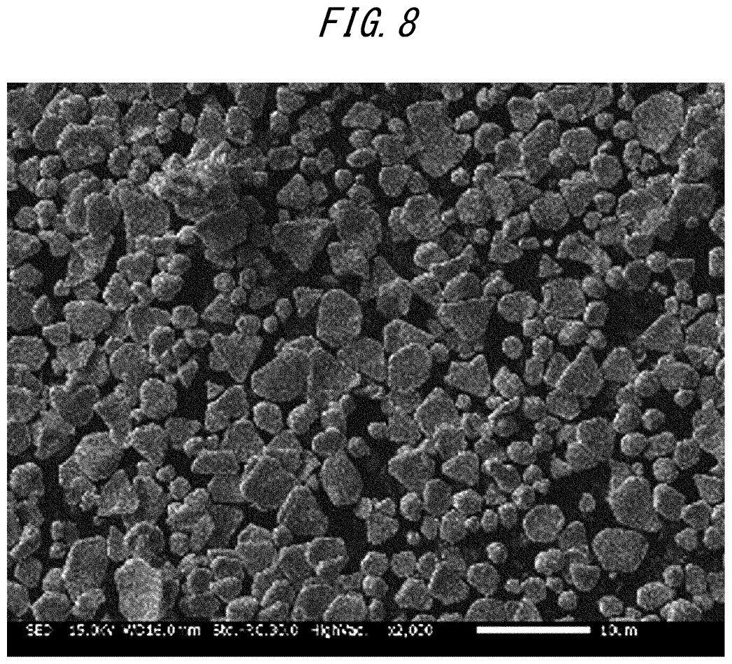

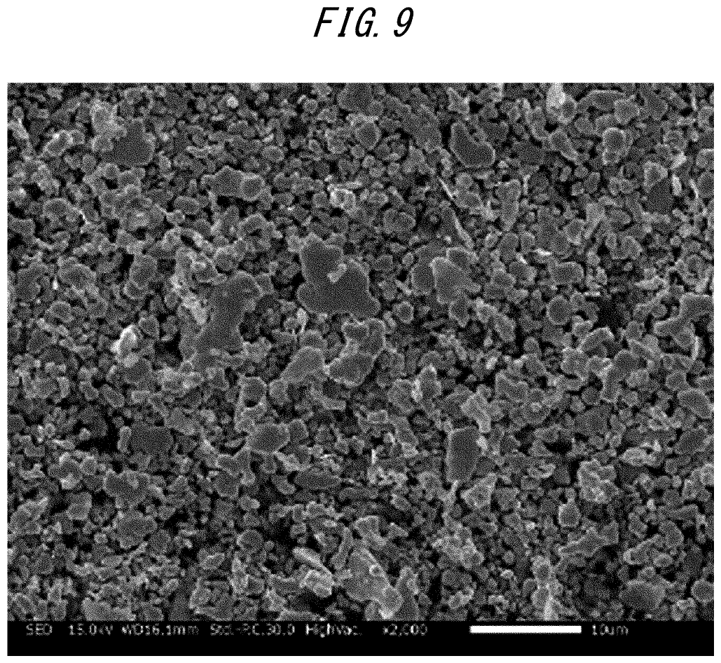

Next, the silver particles were arranged on a stage covered with a conductive adhesive sheet so as not to overlap. SEM observation and creation of IPF and KAM maps of the silver particles in the silver powder were carried out using EBSE-SEM. FIGS. 2 to 7 depict an SEM observation image at 15000× magnification of silver particles, of the silver powders according to Examples 1 to 3 and Comparative Examples 1 to 3, whose main region of the silver particle upper surface is the (111) plane or a plane close to the (111) plane, together with an IPF map from EBSD measurement of the silver particle upper surface and a KAM map. The SEM observation image is marked with symbol A, the IPF map with symbol B, and the KAM map with symbol C. SEM observation images at 2000× magnification illustrating the particle shape of Example 1 and Comparative Example 3 are illustrated in FIGS. 8 and 9, respectively.

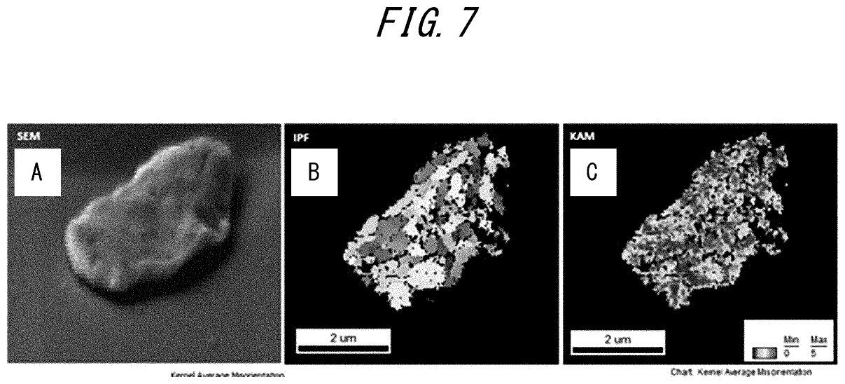

As described above, the plane orientation of the silver powder according to the present disclosure is measured using an Electron BackScatter Diffraction (EBSD) analyzer (OIM Analysis 6.2, manufactured by TSL Solutions Inc.), and the measurement range was 60 μm×180 μm with a step size of 0.30 μm. Measurements were performed with SEM observation conditions of a 15 kV acceleration voltage, 1500× magnification, and 70° tilt. The orientation distribution (Inverse Pole Figure (IPF)) map of the silver particle upper surface was then created by excluding unreliable measurement points with a reliability index (CI value) of 0.2 or less. All silver particles (at least 15) on the IPF map were evaluated, and the percentage of silver particles whose main region of the silver particle upper surface is the (111) plane or a plane close to the (111) plane was evaluated as the IPF value. Silver particles (polycrystalline particles) with many small areas exhibiting various plane orientations in the IPF map of the silver particle upper surface, such as the IPF map (symbol B) in FIG. 7, were observed in the silver particles of Comparative Example 3 even at a magnification of 1500×, and there were no silver particles whose main region of the silver particle upper surface was the (111) plane or a plane close to the (111) plane. The IPF value was therefore set to zero.

Ten or more “silver particles whose main region of the silver particle upper surface is the (111) plane or a plane close to the (111) plane” observed on the IPF map at a magnification of 1500× were then focused on, and further observation was made after increasing the magnification so that one silver particle was in the field of view. The EBSD analyzer was set to a measurement range of 6 μm×18 μm, with a step size of 40 nm, and the SEM observation conditions were the same as the aforementioned measurement method, except that the magnification was set to 15000×. The aforementioned orientation distribution (Inverse Pole Figure (IPF)) map of the silver particle was then created. Here, the strain distribution (Kernel Average Misorientation (KAM)) was acquired using only the silver particle upper surface for 10 or more of the aforementioned silver particles, the KAM values were evaluated, and the average KAM value was calculated from the KAM values of the upper surface of the 10 or more silver particles. In Comparative Example 3 as well, IPF and KAM maps were acquired by the same measurement method for polycrystalline particles, and the average KAM value was calculated. The results are listed in Table 2 below.

### (Conductive Paste Evaluation)

An evaluation of each property of conductive paste was performed as follows.

First, to prepare the conductive paste, 93 mass % of the mixed silver powder obtained in the Examples and Comparative Examples, 3.8 mass % of epoxy resin (EP4901E, manufactured by ADEKA), 1.0 mass % (jER1009, manufactured by Mitsubishi Chemical Corporation), 0.2 mass % of hardener (boron trifluoride monoethylamine complex, manufactured by Wako Pure Chemical Industries, Ltd.), and 2.3 mass % of solvent (BCA: butylcarbitol acetate) were mixed by stirring at 1200 rpm for 30 seconds using a propeller-less self-rotating stirring and defoaming apparatus (VMX-N360, manufactured by EME, Inc.). The result was then passed through a roll gap of 100 μm to 20 μm using three rolls (80S, manufactured by EXAKT) to obtain the conductive paste.

Using the conductive paste obtained by the aforementioned procedure, a screen printer (MT-320T, manufactured by Micro-tec) was used to print a line pattern with a line width of 17 μm and a length of 150 mm to form a conductive paste film. The resulting film was heat-cured at 200° C. for 30 minutes using an air circulation dryer to form a conductive film. The line resistance of each conductive film was measured using a digital multimeter (R6551, manufactured by ADVANTEST).

The evaluation results of the above silver powders, mixed silver powders, and their conductive pastes are listed in Table 2.

TABLE 2

| | | | | | | | Mixed Silver Powder | | | | | |
|---|---|---|---|---|---|---|---|---|---|---|---|---|
| | Silver Powder | | | | | | silver powder | specific | | | | |
| | | | average | aspect | IPF | KAM | indicated to the | surface | | | | line |
| | SSA | D50 | thickness | ratio | value*1 | value | left:Ag-2-1C | area | D10 | D50 | D90 | resistance*2 |
| | m²/g | μm | μm | — | % | ° | mixing ratio | m²/g | μm | μm | μm | μΩ · cm |
| Example 1 | 0.28 | 3.8 | 1.126 | 3.4 | 58 | 0.57 | 1:1 | 0.72 | 0.5 | 1.8 | 6.0 | 80 |
| Example 2 | 0.23 | 3.9 | 1.804 | 2.2 | 48 | 0.84 | 1:1 | 0.72 | 0.4 | 1.1 | 5.5 | 78 |
| Example 3 | 0.17 | 4.3 | 1.998 | 2.2 | 48 | 0.93 | 1:1 | 0.72 | 0.4 | 0.9 | 5.6 | 82 |
| Comparative | 0.21 | 5.2 | 0.855 | 6.1 | 93 | 0.33 | 1:1 | 0.62 | 0.5 | 4.6 | 12.0 | 92 |
| Example 1 | | | | | | | | | | | | |
| Comparative | 0.24 | 4.6 | 1.367 | 3.4 | 92 | 0.39 | 6:4 | 0.70 | 0.5 | 2.2 | 7.2 | 93 |
| Example 2 | | | | | | | | | | | | |
| Comparative | 0.36 | 3.4 | — | — | 0 | 1.23 | 7:3 | 0.54 | 0.6 | 2.0 | 4.2 | 91 |
| Example 3 | | | | | | | | | | | | |

*1ratio of silver particles whose main region of the silver particle upper surface is the (111) plane or a plane close to the (111) plane among all particles
*2evaluation of conductive paste

It was confirmed that the conductive paste using silver powder obtained by the present disclosure has reduced line resistance compared to the Comparative Examples.

The silver powder according to the present embodiment is suitable for use as a conductive filler for conductive pastes. The conductive paste using the silver powder according to the present embodiment can be used to form conductive patterns on substrates and to form electrodes. The conductive paste using silver powder according to the present embodiment can be printed on a substrate by, for example, screen printing, offset printing, or photolithography to form conductive films such as conductive patterns and electrodes (hereinafter also referred to simply as conductive films).

### INDUSTRIAL APPLICABILITY

According to the present disclosure, a silver powder and a mixed powder that can achieve low-resistance electrode wiring when printing wires, and a conductive paste using these powders, can be obtained.

1. A silver powder comprising, as 20% or more and less than 95% of all particles, silver particles whose main region of a silver particle upper surface is a (111) plane or a plane close to the (111) plane, wherein a KAM value of the silver particles is 0.4 or more and 1.0 or less.

2. The silver powder according to claim 1, wherein an aspect ratio yielded by dividing a median diameter on a volume basis according to laser diffraction by an average thickness of the silver particles in cross-sectional measurement is 1.2 or more and less than 4.0.

3. The silver powder according to claim 1, wherein an average thickness of the silver particles in cross-sectional measurement is 310 nm or more.

4. A method for manufacturing silver powder, the method comprising applying strain to a highly crystalline silver powder that includes, as 30% or more of all particles, silver particles whose main region of a silver particle upper surface is a (111) plane or a plane close to the (111) plane, a KAM value of the silver particles being less than 0.4, wherein the strain is applied by applying mechanical energy until the KAM value of the silver particles becomes 0.4 or more and 1.0 or less.

5. The method for manufacturing silver powder according to claim 4, wherein the highly crystalline silver powder is obtained by adding an ascorbic acid-based reducing agent to a silver chelate complex solution after the silver chelate complex solution is prepared by addition of an amino acid.

6. The method for manufacturing silver powder according to claim 4, wherein an aspect ratio, yielded by dividing a median diameter on a volume basis according to laser diffraction by an average thickness of the silver particles in cross-sectional measurement, of silver powder after the applying of strain is 1.2 or more and less than 4.0.

7. The method for manufacturing silver powder according to claim 4, wherein an average thickness of the highly crystalline silver powder in cross-sectional measurement is 310 nm or more, and an average thickness of silver powder in cross-sectional measurement after the applying of strain is 310 nm or more.

8. A method for manufacturing mixed silver powder, the method comprising mixing the silver powder according to claim 1 with micro silver powder having a larger specific surface area than the silver powder.

9. A method for manufacturing mixed silver powder, the method comprising mixing the silver powder according to claim 1 with micro silver powder having a larger specific surface area than the silver powder, wherein the mixing is performed so that a mixing ratio of the silver powder in the mixed silver powder is 10 wt % to 90 wt %.

10. A mixed silver powder comprising at least silver particles whose main region of a silver particle upper surface is a (111) plane or a plane close to the (111) plane, wherein a KAM value of the silver particles is 0.4 or more and 1.0 or less.

11. The mixed silver powder according to claim 10, wherein a specific surface area after mixing is 0.20 m²/g or more and 1.50 m²/g or less.

12. A conductive paste comprising the silver powder according to claim 1, a resin component, and a solvent.

13. A conductive paste comprising the mixed silver powder according to claim 10, a resin component, and a solvent.
